(19) United States
(12) Patent Application Publication
(10) Pub. No.: US 2016/0332765 A1
(43) Pub. Date: Nov. 17, 2016

(54) VIAL LABEL ASSEMBLY

(71) Applicants: Derek William Thompson, Knightdale, NC (US); Bryant James Deakins, Raleigh, NC (US); Brian Marshall Burney, Wake Forest, NC (US)

(72) Inventors: Derek William Thompson, Knightdale, NC (US); Bryant James Deakins, Raleigh, NC (US); Brian Marshall Burney, Wake Forest, NC (US)

(21) Appl. No.: 14/710,073

(22) Filed: May 12, 2015

(51) Int. Cl. B65C 9/26; A61J 1/06; B65C 9/40

(52) U.S. Cl. CPC B65C 9/26; B65C 9/40; A61J 1/06; A61J 2205/30

(57) ABSTRACT

An automated vial label assembly for three-sided pharmaceutical vials includes a conveyor assembly, an elevator assembly, and a printer assembly. The labeling process may be controlled and programmed by a computing device with sensors present at deliberate points throughout the assembly to communicate and transmit information back to the computing device. Such information may include the location and position of the vial, the status of the printed label, and the rotational speed of the container and label assembly. This system may be used to label any size or shape of bottle, including more traditional cylindrical or square shaped containers. The labeling module may be used as a stand-alone labeling system or may be a module used in combination with a larger system such as a pharmaceutical dispensing assembly whereby vials may be sorted, labeled, and filled with the appropriate medications.

### BACKGROUND OF THE INVENTION

The present invention generally relates to an apparatus and method for applying labels to items such as containers, vials, bottles, etc. More specifically, the present invention relates to an apparatus and method of labeling of three-sided pharmaceutical vials. This labeling system may be used as a stand-alone module, or may be used in conjunction with automated prescription filling devices and systems.

When considering the existing methods of a prescription order fulfillment process, it is necessary to affix patient-specific information to the pharmaceutical container. This is typically accomplished by affixing an adhesive-backed label to a container; this label typically being printed with any commercially-available printer. The patient-specific information affixed to the label will include important information such as the patient name, medication type, medication strength and description, physician information, signa, instructions for taking the medication and one or more types of machine-readable information, such as a bar code.

Three-sided bottles have more surface area than a traditional cylindrical bottle of the same volumetric size, and considering the amount of patient and prescription-related information that is required to be affixed to a pharmaceutical bottle when filling a prescription, it would be advantageous to dispense medication in a bottle that has a larger surface area for displaying the required information. However, three-sided bottles (or even four-sided bottles) prove to be more difficult to label, both by hand and by automation. In contrast with a cylindrical bottle, whereby a single label can quickly be wrapped around the circumference of the bottle, a three-sided bottle requires much more precision when applying a label; typically, more than one label needs to be applied (one for each side), and the edges and corners of the bottle must be taken into consideration when applying the label.

A typical label applicator applies one or more labels to an article as the article is conveyed past the label applicator. For example, a label applicator may include a label dispenser, which dispenses a label onto a label receiver or applicator section. The applicator section then transfers the label to the article. This transfer is often accomplished by a blast of gas, typically air, under pressure. Labels used in these applicators are usually secured to a backing strip or release liner by an adhesive, and the backing strip is wound onto a supply reel, fan-folded, or held in some other manner. The backing strip and labels are moved from a holding area through a printing area by a take-up mechanism, such as a reel, and the labels are peeled off of the backing strip by a peel bar, and momentarily retained at an applicator or label receiver. The applicator or label receiver then transfers the label to a passing article.

Known types of label applicators include, but are not limited to, air-jet, synchronous (wipe-on), tamp, corner wrap, flag (wiring cable) and round product applicators. However, typically in these systems there is a measurable gap between the peel bar and the applicator, such as a tamp or transfer head, and the printed adhesive-backed label is removed completely from the backing strip, thereby losing the accurate positioning.

To meet the different requirements of manufacturers and packagers of such products, many types of apparatus and systems have been proposed and are used. U.S. Pat. No. 8,733,416 describes a method for positioning an article within a label applicator and securing the article between a first roller, a second roller, and a moveable contact member. A label is received for application to the article by delivering the label between the article and at least one of the first roller, second roller, and the moveable contact member.

U.S. Pat. No. 6,451,149 describes an apparatus and method for the accurate positioning of die cut printed labels on a backing strip by ensuring that a trailing portion of the printed label remains attached to the backing strip at a pickup point. The apparatus includes a label leading edge indicating sensor and an adjustable peel bar held at a pickup position. The label remains in its die cut position on the backing strip until a vacuum head removes the label and applies it to a product. Therefore, accurate positioning of the printed label is maintained.

U.S. Pat. No. 4,844,771 describes a label applicator and method which can label the forward and rear faces of an article, as well as the other exposed faces of the article, with a printer that can be located immediately adjacent the peeler bar. This apparatus dispenses a printed label onto a label receiver and moves the label receiver along a path toward the article to be labeled, and pivots the label receiver as the label receiver moves along the path.

U.S. Patent Publication No. 2007/0102109 A1 describes an automated pharmaceutical dispensing system with a retrieval subsystem for retrieving a pharmaceutical pack and delivering the pack to a labelling station. The labelling station comprises a label printer and a label applicator subsystem for applying the label to the pack. The system further comprises a delivery subsystem for delivering the pack from the labelling station to a user-accessible point. The label applicator can apply the label at a predetermined position, predetermined orientation or across two discrete planes of the pack.

U.S. Pat. No. 8,986,476 describes an apparatus and method for fulfillment of patient prescription orders by adapting a stock container pre-filled with medication for use as a patient-specific container through precise application of patient-specific information to the pre-filled container. In general, preferred embodiments comprise a control apparatus and information-application apparatus. A printer applies patient-specific information on a label. A positioner orients the pre-filled container to receive the label from the printer such that information provided with the container is available for use.

All of the above-referenced U.S. patents are hereby incorporated by reference, in their entirety.

Disadvantages of the use of known label applicators or hand application of labels include indiscriminate application of the labels, the amount of time required to apply labels by hand, and errors that could occur through improper or inaccurate labeling. Indiscriminate application of a pharmaceutical label represents a problem to pharmacy management because some of the information provided on the containers may be covered and obscured by the label. As a result, the information provided with the container may be rendered unusable to pharmacy management, patient or others in the prescription order fulfillment chain. Furthermore, when using a label applicator to apply a label to a three-sided container, the timing of the steps in the labeling process is very important. The timing of printing the label, transporting the label to the container, and the positioning of the container must all be synchronous. If the timing is off for any one step, the label will not be applied properly.

It would therefore be advantageous to provide an automated, streamlined apparatus and process for labeling containers, specifically pharmaceutical containers of different sizes and shapes. It would be particularly advantageous to provide a product and method that employs the use of sensors and computer feedback to eliminate the need to precisely time each step in the labeling process. It would be further advantageous to provide an apparatus and method for labeling containers that could be used alone or adapted to be used in conjunction with current pharmaceutical dispensing systems.

### BRIEF SUMMARY OF THE INVENTION

In one aspect of the present invention, an automated vial label assembly is provided. A preferred embodiment of the present invention comprises a conveyor assembly, an elevator assembly, and a printer assembly. During the labeling process, a vial or container may travel from the conveyor assembly to the elevator assembly, where a label printed by the printer assembly is applied to the container. The labeling process may be controlled and programmed by a computer or another suitable information processing device. Sensors are present at deliberate points throughout the assembly to communicate and transmit information back to the computing device. Such information may include the location and position of the vial, the location and status of the printed label, and the rotational speed of the container and label assembly.

The label assembly system of the present invention is fully automated and is described herein in terms of labeling a three-sided, triangular shaped pharmaceutical vial; however, this system may be used to label any size or shape of bottle, including more traditional cylindrical and square shaped containers, which may or may not be used for pharmaceutical purposes.

The present invention may be used as a stand-alone labeling system or may be a module used in combination with a larger system such as a pharmaceutical dispensing assembly whereby vials may be sorted, labeled, and filled with the appropriate medications, for example.

### DESCRIPTION OF THE DRAWINGS

These and other features, aspects, and advantages of the present invention will become better understood with regard to the following description, appended claims, and accompanying drawings where:

FIG. 1a illustrates a perspective view of a preferred embodiment of the label assembly system, wherein a vial has been transported from the conveyor assembly to the cup of the elevator assembly.

FIG. 1b illustrates a perspective view of a preferred embodiment of the label assembly, wherein a vial is raised in position to be labeled.

FIG. 2 illustrates a perspective view of one embodiment of the conveyor assembly, whereby a vial is shown traveling down the conveyor toward the sensor.

FIG. 3 illustrates a perspective view of a preferred arrangement of the conveyor assembly adjacent to the elevator assembly of the present invention.

FIG. 4a illustrates a perspective view of one embodiment of the elevator assembly with the platform in the lowered position and a vial present in the cup.

FIG. 4b illustrates a perspective view of one embodiment of the elevator assembly with the platform raised and a vial positioned between the platform and the pilot.

FIG. 5 illustrates a perspective view of one embodiment of the printer assembly.

FIG. 5a illustrates a close-up perspective view of inset “A”, showing one embodiment of the label transfer assembly.

FIG. 6 illustrates a perspective view of one embodiment of the printer assembly showing a printed label rolling onto the label transfer assembly and triggering the label sensor.

FIG. 6b illustrates a close-up perspective view of inset “B”, showing a printed label rolling onto the label transfer assembly and triggering the label sensor.

FIG. 7a illustrates a perspective view of one embodiment of the elevator assembly and adjacent printer assembly, showing a vial present in the cup of the elevator assembly.

FIG. 7b illustrates a perspective view of one embodiment of the elevator assembly and adjacent printer assembly, showing a vial in position for labeling.

### DETAILED DESCRIPTION OF THE INVENTION

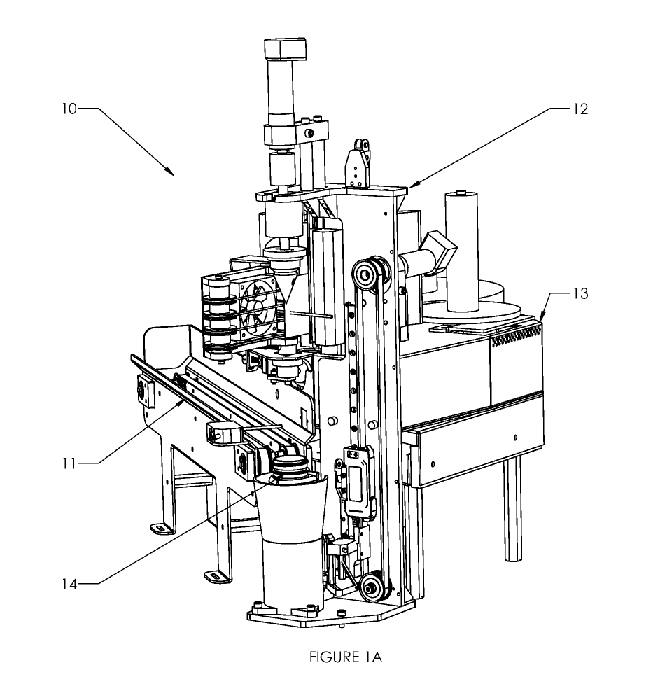

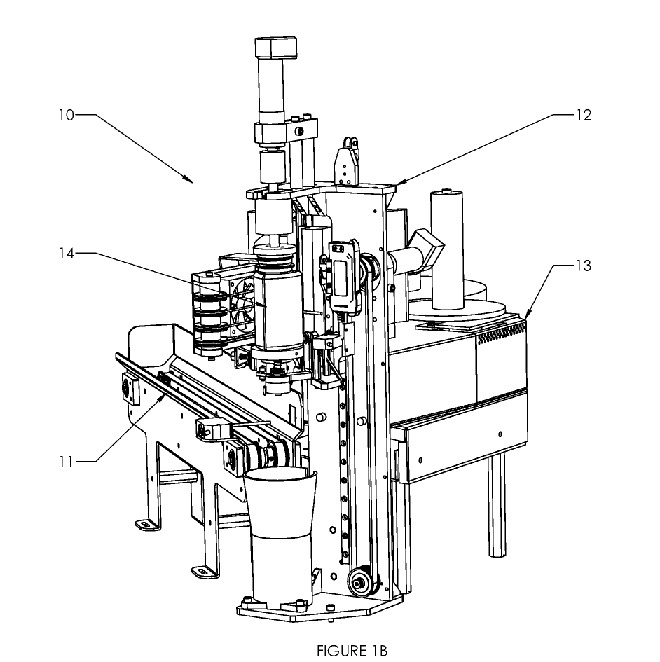

A preferred embodiment of the automated vial label assembly 10 of the present invention comprises an optional conveyor assembly 11, an elevator assembly 12, and a printer assembly 13, as shown in FIGS. 1a-7b. FIG. 1a shows one arrangement of a vial labeling assembly 10 wherein a three-sided vial 14 (also referred to herein as a container) has already passed through the conveyor system 11 and into the cup 19 of the elevator assembly 12. FIG. 1b shows this same arrangement of the overall vial label assembly 10; however, in this illustration the vial 14 and label transfer assembly 33 are in position for the label 38 to be readily applied.

Preferred embodiments of the components of the vial label assembly are outlined below, followed by a detailed description of a preferred contemplation of the entire labeling process.

### Conveyor Assembly

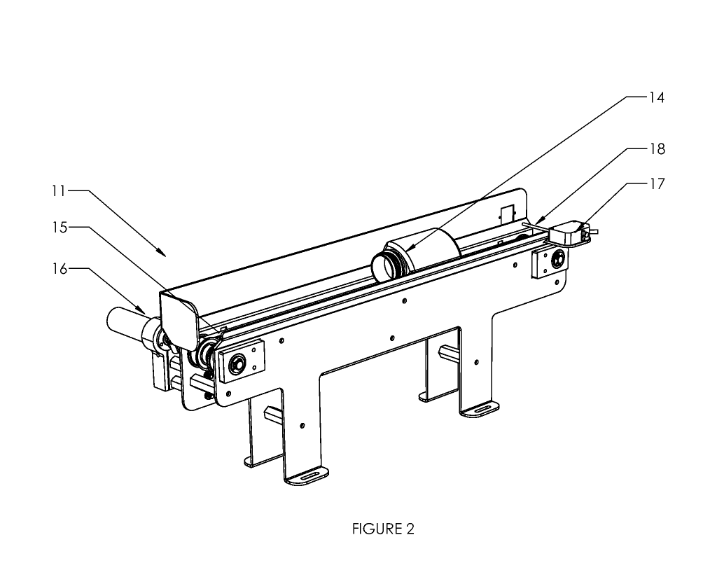

The conveyor assembly 11, as shown in FIG. 2, preferably comprises a belt 15 or belts driven by a motor 16, and may be designed in any length or size suitable for the module. When in use, a vial or container 14 is dropped on the conveyor assembly 11 in an orientation such that the closed bottom of the container 14 is traveling toward the end of the conveyor 15. A proximity sensor 17 may be present at the end of the conveyor assembly 11 to sense when a vial 14 is nearing the edge or has reached the end of the conveyor 15. This sensor 17 may be any suitable sensor, such as a LED light-based sensor.

### Elevator Assembly

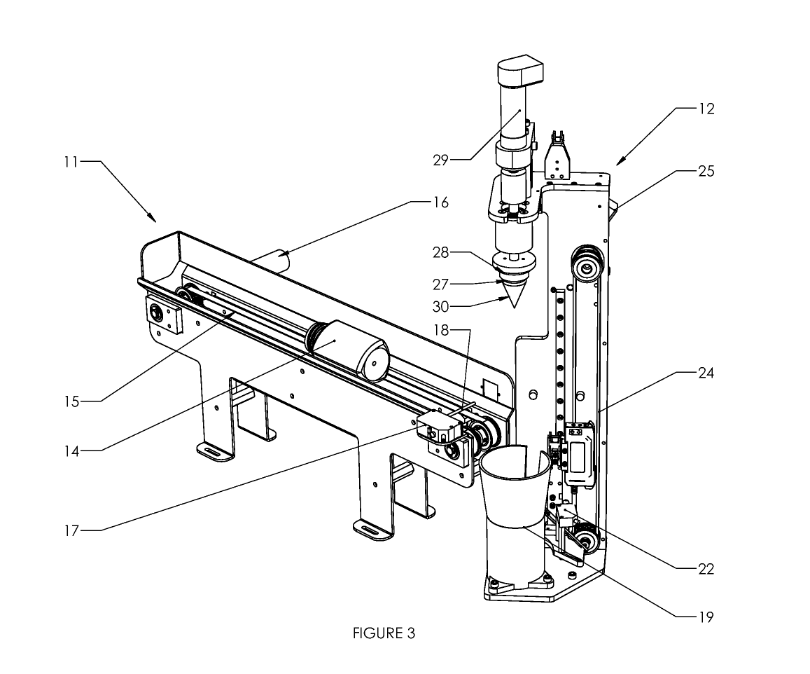

Shown in FIG. 3, the conveyor assembly 11 is preferably adjacent to the elevator assembly 12. In one embodiment, the elevator assembly 12 comprises components such as a receptacle or cup 19 for catching the vial 14 as it falls from the conveyor belt 15, a rotatable platform 20, a pilot 30 for aligning and rotating the vial 14, a motor 25 for raising and lowering the platform 20, a motor 25 for driving the rotation of the vial 14, and sensors 21, 22 to communicate and transmit information to be used in the labeling process. As previously described, the labeling process may be controlled and programmed by a computer or another suitable information processing device. This computing device will compile the information provided by the assembly sensors for use in an algorithm that runs the vial labeling process.

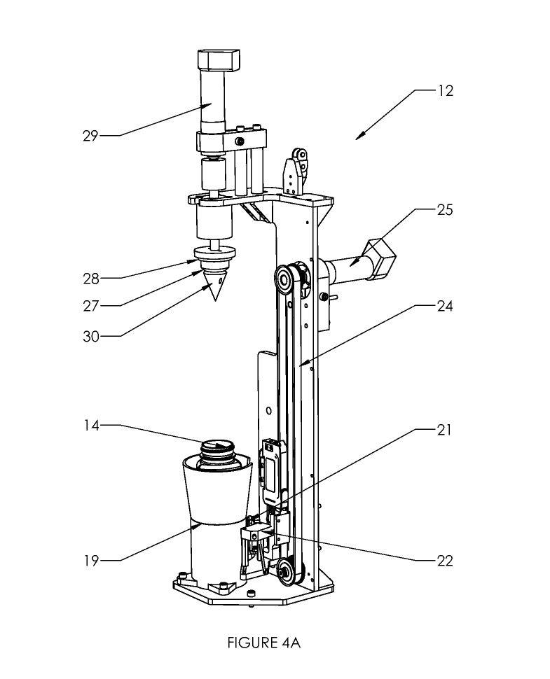

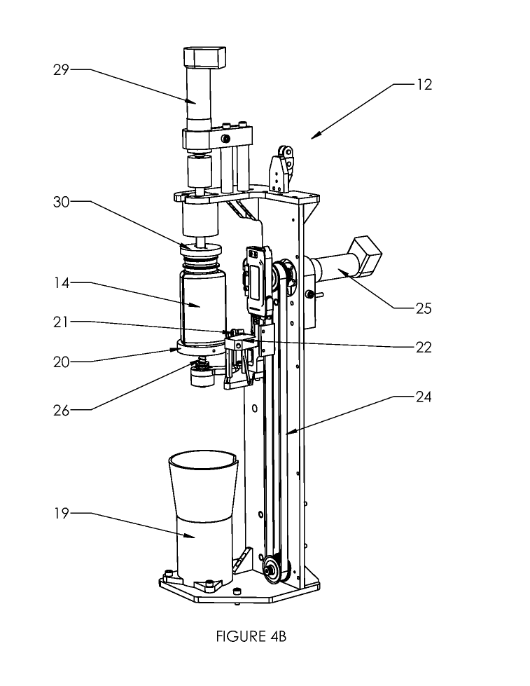

The conveyor 11 and elevator assembly 12 are positioned such that the end of the conveyor belt 15 may accurately drop the container 14 into a cup 19 preferably present on lower portion of the elevator assembly 12. This cup 19 is for receiving the container 14 as it drops off the conveyor belt 15. The elevator assembly 12 also includes a platform 20 that raises and lowers in response to where the container 14 is located on the elevator assembly 12. For instance, once the container 14 passes through the light beam 18 of the sensor 17 on the conveyor assembly 11, thus triggering the sensor 17 that the container 14 has reached the end of the conveyor 15, the platform 20 on the elevator assembly 12 may lower down into the bottom of the cup 19. In this way, the container 14 drops off the conveyor 15 and into the cup 19, landing open side up on top of the platform 20, as seen in FIG. 4a. In a preferred embodiment, the platform 20 on elevator assembly 12 moves up and down in a vertical direction, contrary to most label applicators which proceed through a labeling process in a horizontal direction; however, it is to be noted that the elevator assembly of the present invention may be designed to move in any direction as desired and may not be limited to only vertical movement.

In a preferred embodiment, the platform 20 is spring-loaded and rotatable and may be raised and lowered through mechanical means such as a motor 25 driven belt system 24. FIG. 4a shows the platform 20 lowered into the cup 19, while FIG. 4b shows the elevator assembly 12 with the platform 20 in a raised position. When a container 14 is loaded onto the platform 20, the platform 20 can be raised to meet a pilot 30 preferably on the upper portion of the elevator assembly 12. The pilot 30 serves to align the container 14 for labeling (see FIG. 4b) and rotates the container 14 on axis for labeling. The pilot 30 may be powered by a motor and shaft assembly 29 or other suitable means that rotates the pilot 30; the container 14 is aligned by the pilot 30 and rotates on axis with the pilot 30 for application of the label 38. The optional spring portion 26 of the platform 20 allows for the container 14 to be pushed tightly around the pilot 30 for a secure fit.

It is contemplated in an alternative embodiment that, rather that the container 14 being raised to the pilot 30 by a spring-loaded platform 20, instead the container 14 may remain stationary at a receiving point and the pilot 30 may be lowered down to meet the container 14. In this embodiment, the pilot 30 may be spring-loaded to allow for the container 14 to be pushed tightly around the pilot 30 as the pilot 30 is lowered into the opening of the container 14. In this embodiment, the container 14 still remains capable of being rotated on axis for label application.

In a preferred embodiment, the pilot 30 is conical shaped and may include different steps or grooves 27 to accommodate different diameters of bottle openings (see FIG. 4a); a container 14 with an opening of a smaller diameter would be stopped shorter on the pilot 30 than a container 14 with a larger diameter opening. Additionally, the pilot 30 may include at least one rubber gasket 28 or O-ring to facilitate frictional engagement between the container 14 and the pilot 30.

Preferably, at least two sensors may be present on the platform 20 component of the elevator assembly 12 for 1) sensing when a container 14 is present on the platform 20, and 2) sensing proper alignment of the container 14, as well as determining the edges and sides of the container 14 prior to labeling. The sensors may be mechanical, acoustic, photo, or any other suitable type of sensor. The first sensor 21 is a proximity sensor for sensing the presence of a container 14 on the platform 20, preferably a fiber optic sensor or LED light sensor. The second sensor 22 (also referred to herein as an “alignment sensor”) is preferably a LED light sensor. Any person skilled in the art would know what type of sensor may be best suited for a particular function.

In one embodiment, the alignment sensor 22 may be mounted adjacent to the platform 20, preferably directly adjacent to or in close proximity to where the container 14 will sit on the platform 20. The vial rotation motor 29, or another suitable rotation means, rotates the container 14 while the alignment sensor 22, determines the edges and the sides of the container 14 to verify the position of the vial 14. This determination process, described in greater detail below, is performed to ensure the container 14 is positioned properly prior to applying the label 38. The alignment sensor data is sent to a computer where a computer algorithm is used to control the labeling process.

### Printer Assembly

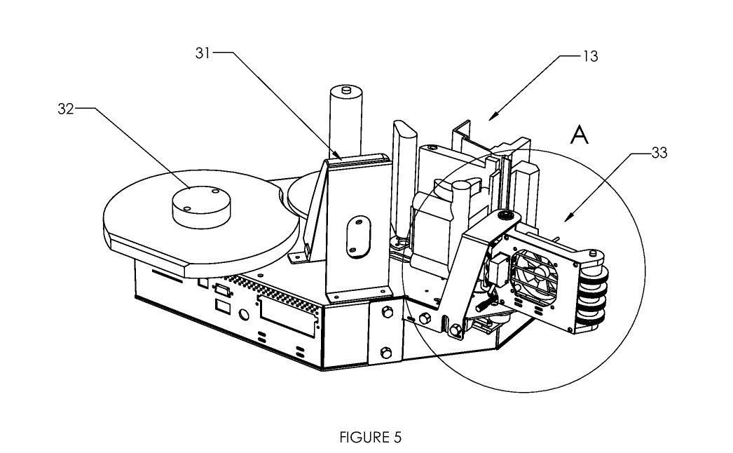

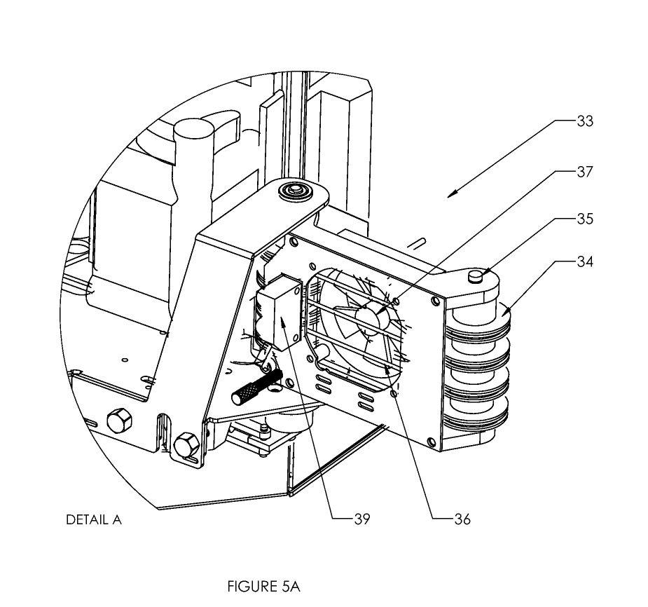

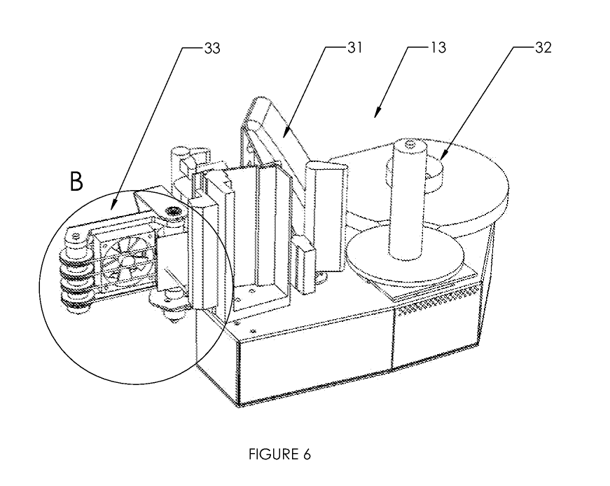

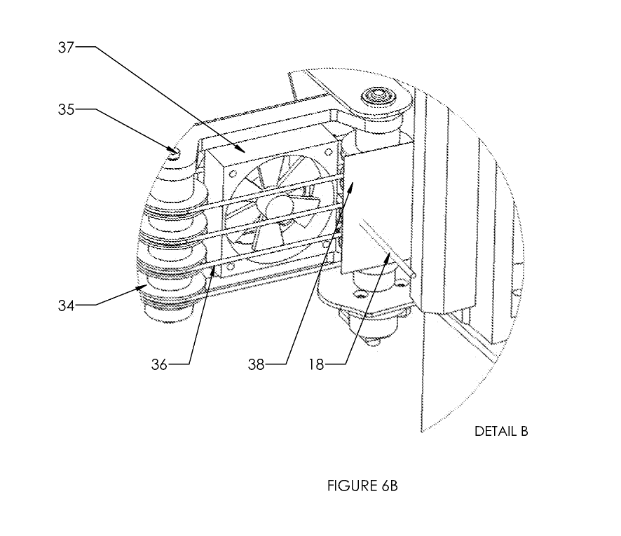

Adjacent to the elevator assembly 12 is the printer assembly 13, as illustrated in FIGS. 5-6b. In a preferred arrangement, the printer assembly 13 comprises a printer 31, a label transfer assembly 33 with sensor 39, and ready to print or pre-printed labels or spools 32 of labels. The printer 31 may be any suitable printer as desired for a particular machine and/or use. Labels 38 may be chosen based on the size and shape of the container to which they are being affixed.

As shown in FIGS. 5a and 6b, the label transfer assembly 33 includes a means for rolling 34, 35, 36 the label 38 across the transfer assembly 33 and a means for providing vacuum force 37 as the label 38 travels across the transfer assembly 33. In a preferred arrangement illustrated by FIG. 6b, the label transfer assembly 33 is comprised of at least two shafts 35 with a series of pulleys 34 encircling each shaft 35. In one embodiment, the shaft 35 may be stationary, while the pulleys 34 may be connected in series around a cylindrical tube that may rotate around the stationary shaft 35 through means such as ball bearings. In this way, the pulleys 34 may rotate together as one piece around the shaft 35. Or in an alternative embodiment, the shaft 35 may rotate in conjunction with the pulleys 34. A series of belts, cables, O-rings, or the like, may be arranged around each pulley such that each belt 36 connects the pulleys 34 of the adjacent shaft 35. And, a fan 37 may be provided either between or behind the belts 36 to provide vacuum force so that as the label 38 travels across the label transfer assembly 33 to meet the container 14, the label 38 remains upright and held in position against the belts 36 as it is dispatched from the printer 31 to the container 14.

A proximity sensor 39, shown in FIG. 5a, may be present on the label transfer assembly 33, preferably positioned at the edge of the label transfer assembly 33 adjacent to the printer 31, such that the label 38 passes by the sensor 39 (see FIG. 6b) as soon as the label 38 comes in contact with the belts 36 of the label transfer assembly 33. This sensor 39 may tell the vial rotation motor 29 that a label 38 is ready for application. For simplification of the assembly, in a preferred embodiment, the pulleys 34 and belts 36 of the label transfer assembly 33 may be passive and, therefore, not require a motor for movement. Instead, the rotation of the container 14 via the vial rotation motor 29 can drive the rotation of the transfer assembly belts 36. However, it is contemplated that the label transfer assembly may be powered by other means such as a motor, if so desired.

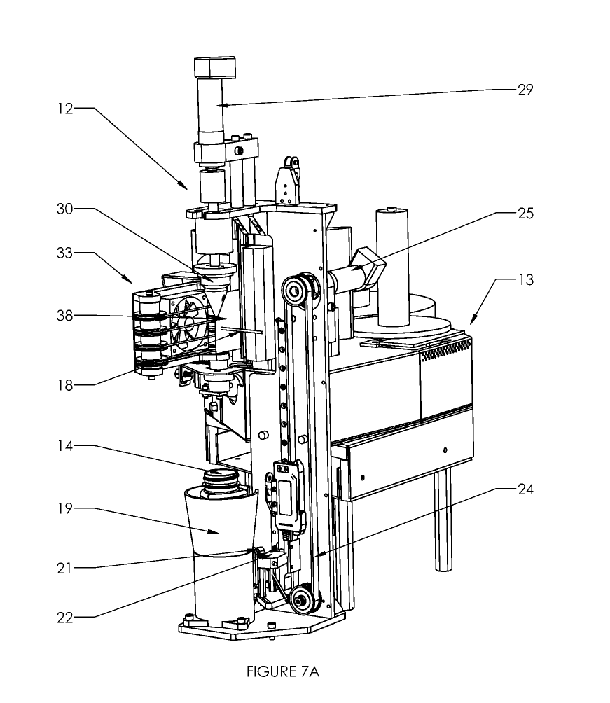

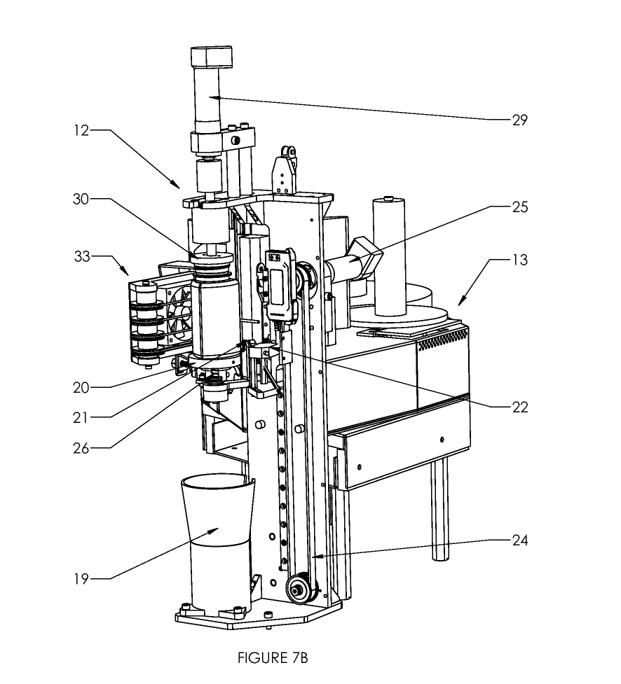

FIG. 7a illustrates the printer assembly 13 and elevator assembly 12 adjacent to one another. A label 38 has been dispatched from the printer 31 and is passing through a light beam 18 of the proximity sensor 39 on the label transfer assembly 33. FIG. 7b illustrates the same arrangement shown by FIG. 7a, except the container 14 is now in position and driving the rotation of the transfer assembly belts 36.

### Preferred Labeling Process

A preferred process is described herein. The vial label assembly of the present invention is not to be limited to this process; it is to be understood that this process may be altered or adjusted as required or desired.

In one preferred process, a container 14 may be dispensed onto the conveyor assembly 11 in such a way that the bottom or closed end of the container 13 travels in the direction of the belts 15, toward the end of the conveyor assembly 11. As the container 14 reaches the end of the conveyor 15, it triggers a proximity sensor 17 present at the end of the conveyor belt 15. The triggering of the conveyor sensor 17 alerts the platform 20 to lower into the cup 19 of the elevator assembly 12. The container 14 continues to move past the sensor 17 until the container 14 is dropped into the cup 19 and onto the platform 20.

It is contemplated that the container 14 may be transported to the elevator assembly 12 through methods other than the conveyor assembly 11. For example, in an alternative process, the container 14 may be transported to the elevator assembly 12 by hand, robotic arm, or another suitable method.

When a first proximity sensor 21 on the platform 20 senses the presence of a container 14, the elevator platform motor 25 triggers the belt 24 that raises the platform 20 and container 14 up to a pilot 30, where the pilot 30 centers the container 14 for labeling. When the container 14 is engaged with the pilot 30, a vial rotation motor 29 drives the rotation of the container 14 while the alignment sensor 22, locates or determines the edges and sides of the container 14 to ensure proper vial positioning for label application. For example, in the case of a three-sided container, when the alignment sensor 22 senses a corner or edge of the container 14, it then looks for another corner at 120 degrees from the first corner; once that corner is determined, the sensor looks for a third corner at 120 degrees from the second corner; once the third corner is determined, the sensor again looks for the original (first) corner at 120 degrees from the third corner. If the sensor determines more or less than 120 degrees (for example, if the sensor begins measuring degrees at a seam or artifact of the container rather than an actual corner or edge), then the determination of each edge may start over at the next detectable corner to ensure that all sides of the container have been properly detected. The number of degrees measured per side is dependent upon the shape of the container. For example: if the container is four-sided, the sensor may count 90 degrees from a detectable edge; if the container is cylindrical, the sensor may detect a point on the container and count 360 degrees back to the original point. As the alignment sensor 22 detects the sides and corners of the container 14, it sends this information back to the computing device, where it can be compiled in the algorithm of the labeling process.

Once the container 14 is properly aligned by the proximity and alignment sensors 21, 22, the control computer transmits to the printer assembly 13 that the container 14 is ready for labeling. The label transfer assembly 33 moves into place, coming into contact with the side of the container 14, and printer 31 prints the label(s) 38. The vial rotation motor 29 spins the container 14 as directed by the control computer using encoder feedback to control speed, which in turn moves or spins the belts 36 on the label transfer assembly 33. The printed label 38 is dispatched from the printer 31 and rolls along the belts 36 of the transfer assembly 33. The label 38 is held against the belts 36 by a vacuum force created by the fan 37 of the transfer assembly 33 until the label 38 passes through the proximity sensor 39 and reaches the container 14. The container 14 begins to rotate and the first edge of the label is applied to the first edge of the container. The rotation of the container 14 drives the rest of the label 38 to be applied to the first side of the container 14. The container 14 continues to rotate as the label 38 rolls along the belts 36, until the entire label 38 is applied to the first side of the container 14, at which point the container 14 has rotated beyond the starting point of the next label. The vial rotation motor 29 then reverses the rotation of the container 14 to an extent whereby the container 14 is now in proper position for the labeling of the second (next) side of the container. The same rotation/reverse rotation process may repeat until the container 14 has been labeled as desired by the end user, at which point the label transfer assembly 33 opens away from the container 14, and the elevator assembly 12 lowers the container 14 so that it may be removed or transported to the next step in an automated pharmaceutical dispensing process.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A vial label assembly for automated labeling of a container, said vial label assembly comprising:
an elevator assembly for receiving said container and for moving said container from a first location to a second location;
a printer assembly located adjacent to said elevator assembly for printing a label and dispatching said label to said container for application; and
at least one proximity sensor located on said elevator assembly at said first location for sensing the presence of said container.

2. The vial label assembly of claim 1, further including;
at least one alignment sensor located on said elevator assembly, whereby said alignment sensor calculates proper alignment of said container prior to labeling; and
at least one proximity sensor located on said printer assembly for communicating the presence of said label to said elevator assembly.

3. The vial label assembly of claim 1 further including a conveyor assembly located adjacent to said elevator assembly for conveying said container to said first location.

4. The vial label assembly system of claim 3, whereby said conveyor assembly further includes a proximity sensor located at a terminal end of said conveyor assembly for sensing when said container reaches said first location.

5. The vial label assembly of claim 1, whereby said elevator assembly further includes:
a receptacle adapted for receiving said container and being located on said elevator assembly at said first location;
a rotatable platform for transporting said container from said first location to said second location;
a pilot at said second location for receiving the open end of said container;
a vial rotation motor operably connected to said pilot for rotating said pilot;
a proximity sensor on said platform for sensing the presence of said container on said platform; and
an alignment sensor on said platform for sensing the alignment of said container on said platform.

6. The vial label assembly of claim 5, whereby said pilot is conical shaped.

7. The vial label assembly of claim 1, whereby said printer assembly includes a printer for printing a label, and a label transfer assembly located adjacent to said printer such that said label may roll from said printer to said label transfer assembly.

8. The vial label assembly of claim 7, whereby said label transfer assembly further includes:
at least two shafts connected by a rotatable pulley system;
a means for providing vacuum force located between said shafts to provide vacuum force to said label as said label passes over said label transfer assembly; and
a proximity sensor located on the edge of said label transfer assembly adjacent to said printer for communicating the presence of said label as said label passes from said printer to said label transfer assembly.

9. The vial label assembly of claim 8, whereby said means for providing vacuum force is a fan.

10. The vial label assembly of claim 1, whereby said proximity sensor is a LED light sensor.

11. The vial label assembly of claim 1, whereby said alignment sensor is a LED light sensor.

12. A vial label assembly for automated labeling of a multi-sided pharmaceutical container, said vial label assembly comprising:
an elevator assembly for receiving a multi-sided container and moving said container from a first location to a second location;
a printer assembly located adjacent to said elevator assembly for printing a label and dispatching said label to said multi-sided container for application;
at least one proximity sensor located on said elevator assembly at said first location for sensing the presence of said multi-sided container;
at least one alignment sensor located on said elevator assembly, whereby said alignment sensor calculates proper alignment of said multi-sided container prior to labeling; and
at least one proximity sensor located on said printer assembly for communicating the presence of said label to said elevator assembly.

13. The vial label assembly of claim 12, whereby said multi-sided container has three sides.

14. A vial label assembly for automated labeling of a container, said vial label assembly comprising:
an elevator assembly for receiving said container;
a means for rotating said container on axis for label application, said means for rotating being operably connected to said elevator assembly such that said elevator assembly may move said means for rotating from a first location to a second location; and
a printer assembly located adjacent to said elevator assembly for printing a label and dispatching said label to said container for application.

15. The vial label assembly of claim 14, whereby said means for rotating said container on axis for labeling is a pilot that may be inserted into the top opening of said container.

16. A process for labeling a multi-sided container comprising the steps of:
providing an elevator assembly for receiving a container;
providing a printer assembly located adjacent to said elevator assembly;
providing at least one proximity sensor on said elevator assembly for detecting the presence of said container;
providing at least one alignment sensor located on said elevator assembly for detecting proper alignment of said container;
providing at least one proximity sensor located on said printer assembly for communicating the presence of a label;
transporting said container to said elevator assembly;
detecting said container by said proximity sensor;
determining at least one side of said container to ensure proper alignment prior to labeling;
transmitting signal to said printer assembly that said container is ready for labeling;
dispatching said label from said printer assembly;
detecting presence of said label via said proximity sensor on said printer assembly;
transmitting signal of presence of said label to said elevator assembly to begin rotation of said container;
rotating said container; and
applying said label to said container.

14. The process for labeling a multi-sided container as in claim 9, further comprising the steps of:
providing a label transfer assembly including a means for transporting said label from said printer assembly to said container on said elevator assembly; and
providing vacuum force on said label as said label passes over said label transfer assembly to said container.
